(19) United States
(12) Patent Application Publication
(10) Pub. No.: US 2009/0003973 A1
(43) Pub. Date: Jan. 1, 2009

(54) Wafer transfer robot

(75) Inventors: Yong Won Choi, Yongij-si (KR); Kyung Won Kang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/078,179

(22) Filed: Mar. 27, 2008

(30) Foreign Application Priority Data
Jun. 29, 2007 (KR) 10-2007-0065120

(51) Int. Cl. B25J 1/02

(52) U.S. Cl. 414/4; 414/1; 414/7; 901/27

(57) ABSTRACT

A wafer transfer robot, having a robot hand which transfers a wafer in an improved driving manner by changing a driving force transfer device of the robot hand, is disclosed. The wafer transfer robot having at least robot hand to transfer a wafer includes an arm frame supported on an elevating shaft to vertically move the robot hand, wherein the robot hand includes a first robot arm rotatably supported on the arm frame, a second robot arm rotatably supported at an end of the first robot arm, a first driving device which rotates the first robot arm to rotate the robot hand, a second driving device which rotates the second robot arm to extend and contract the robot hand in a radial direction with the first driving device, and a controller which operates the first driving device and stops the second driving device when the robot hand is rotated, and operates both the first driving device and the second driving device at the same time when the robot hand is extended and contracted in a radial direction. The wafer transfer robot can be rotated and linearly move in a radial direction by providing the first driving device and the second driving device on the robot hand, thereby greatly decreasing the capacity of the motor serving as a driving device and reducing the cost.

### CROSS-REFERENCE TO RELATED APPLICATIONS

This application claims the benefit of Korean Patent Application No. 2007-0065120, filed on Jun. 29, 2007 in the Korean Intellectual Property Office, the disclosure of which is incorporated herein by reference.

### BACKGROUND

1. Field

Embodiments relate to a wafer transfer robot, and, more particularly, to a wafer transfer robot having a robot hand which transfers a wafer in an improved driving manner.

2. Description of the Related Art

Generally, a liquid crystal display device is manufactured by repeatedly performing a thin film deposition process in which a thin film of a dielectric material or the like is deposited on a glass substrate, a photolithography process in which the thin film is selectively exposed or covered using a photosensitive material, an etching process in which the remaining thin film is removed for patterning in a desired shape, a cleaning process for removing residues and the like. Each process is performed in a chamber having an optimal environment for the process.

A wafer transfer robot is disposed in a transfer chamber, and a number of processing chambers are disposed around the transfer chamber. Since the processing chambers are arranged while being spaced at a specified distance from the transfer chamber, the wafer transfer robot is rotatably disposed to transfer a wafer from one processing chamber to another processing chamber. Further, the wafer transfer robot is disposed to be linearly movable in a radial direction to load or unload the wafer into or from the chamber.

FIG. 1 illustrates a front view of a conventional wafer transfer robot.

As shown in FIG. 1, the wafer transfer robot includes a base 1 disposed at the lower side to be movable in a horizontal direction; a rotation frame 2 rotatably installed on the base 1; an elevating shaft 3 formed upward from the rotation frame 2; an arm frame 4 disposed on the elevating shaft 3 to be vertically movable; a first robot arm 5 and a second robot arm 6 capable of contracting to and extending with respect to the arm frame 4; and a wafer holding member 7 disposed at the end of the second robot arm 6 to support the wafer. A robot hand 8 is configured to include the first robot arm 5, the second robot arm 6 and the wafer holding member 7.

In this case, the rotation of the wafer transfer robot is performed by the rotation frame 2 disposed at the lower side of the wafer transfer robot. A motor (not shown) and a decelerator (not shown) are disposed in the rotation frame 2. Accordingly, the rotation frame 2 rotates on the base 1 by a rotational force of the motor transferred through the decelerator.

However, in case of a wafer transfer robot for transferring a large wafer, the wafer holding member 7, the first robot arm 5 and the second robot arm 6 have large sizes and weights. Also, the arm frame 4 for mounting the first robot arm 5 and the second robot arm 6 has a large size and weight. Thus, a motor having a very large capacity is used to drive the rotation frame 2 and the capacity of the decelerator and a controller increases, thereby increasing the cost.

### SUMMARY

Embodiments solve the above problems. It is an aspect of embodiments to provide a wafer transfer robot having a robot hand which transfers a wafer in an improved driving manner by changing a driving force transfer device of the robot hand.

In accordance with an aspect of an embodiment, there is provided a wafer transfer robot having at least robot hand to transfer a wafer including an arm frame supported on an elevating shaft to vertically move the robot hand, wherein the robot hand includes: a first robot arm rotatably supported on the arm frame; a second robot arm rotatably supported at an end of the first robot arm; a first driving device which rotates the first robot arm to rotate the robot hand; a second driving device which rotates the second robot arm to extend and contract the robot hand in a radial direction with the first driving device; and a controller which operates the first driving device and stops the second driving device when the robot hand is rotated, and operates both the first driving device and the second driving device at the same time when the robot hand is extended and contracted in a radial direction.

When the first driving device and the second driving device are operated at the same time, the first robot arm and the second robot arm may rotate in opposite directions to each other, and a rotational speed of the second robot arm is twice a rotational speed of the first robot arm.

The wafer transfer robot may further include a wafer holding member rotatably supported on the second robot arm, wherein the second robot arm and the wafer holding member rotate in opposite directions to each other, and a rotational speed of the second robot arm is twice a rotational speed of the wafer holding member.

The first driving device may include a first driving motor and a first transfer device which transfers an output of the first driving motor to the first robot arm.

The first transfer device may include a first supporting shaft which connects the arm frame and the first robot arm and a belt which transfers the output of the first driving motor to the first supporting shaft.

The second driving device may include a second driving motor and a second transfer device which transfers an output of the second driving motor to the second robot arm and the wafer holding member.

The second transfer device may include a second supporting shaft which connects the first robot arm and the second robot arm, a third supporting shaft which connects the second robot arm and the wafer holding member, and a belt which transfers the output of the second driving motor to the second supporting shaft and the third supporting shaft.

The robot hand may be provided as a pair of robot hands on the arm frame to be vertically symmetrical.

In accordance with an aspect of an embodiment, there is provided a wafer transfer robot including a robot hand for transferring a wafer, the robot including a first robot arm; a second robot arm rotatably supported at an end of the first robot arm; a first driving device which rotates the first robot arm to rotate the robot hand; a second driving device which rotates the second robot arm to extend and contract the robot hand in a radial direction with the first driving device; and a controller which operates the first driving device and stops the second driving device when the robot hand is rotated, and operates both the first driving device and the second driving device at the same time when the robot hand is extended and contracted in a radial direction.

### BRIEF DESCRIPTION OF THE DRAWINGS

These and/or other aspects, features, and advantages of exemplary embodiments of the invention will become apparent and more readily appreciated from the following description of exemplary embodiments, taken in conjunction with the accompanying drawings, of which:

FIG. 1 illustrates a front view of a conventional wafer transfer robot;

FIG. 2 illustrates a plan view of a wafer transfer robot according to an exemplary embodiment;

FIG. 3 illustrates a longitudinal cross-sectional view of the wafer transfer robot according to an exemplary embodiment;

FIG. 4 is an operation state diagram showing rotation of a robot hand according to an exemplary embodiment;

FIG. 5 is an operation state diagram showing extension and contraction of the robot hand in a radial direction according to an exemplary embodiment; and

FIG. 6 is an operation flowchart of a controller of the robot hand according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to like elements throughout. Exemplary embodiments are described below by referring to the figures.

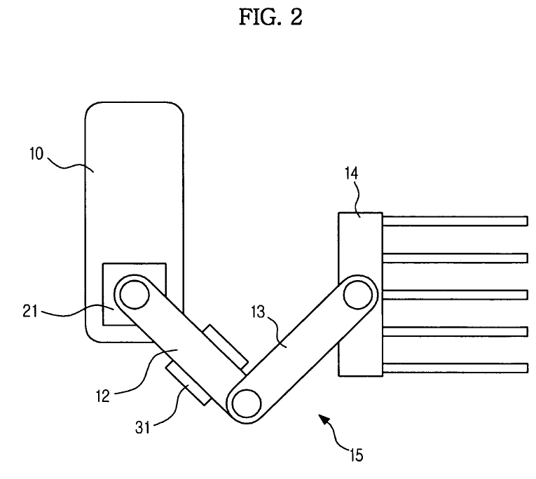

FIG. 2 illustrates a plan view of a wafer transfer robot according to an exemplary embodiment.

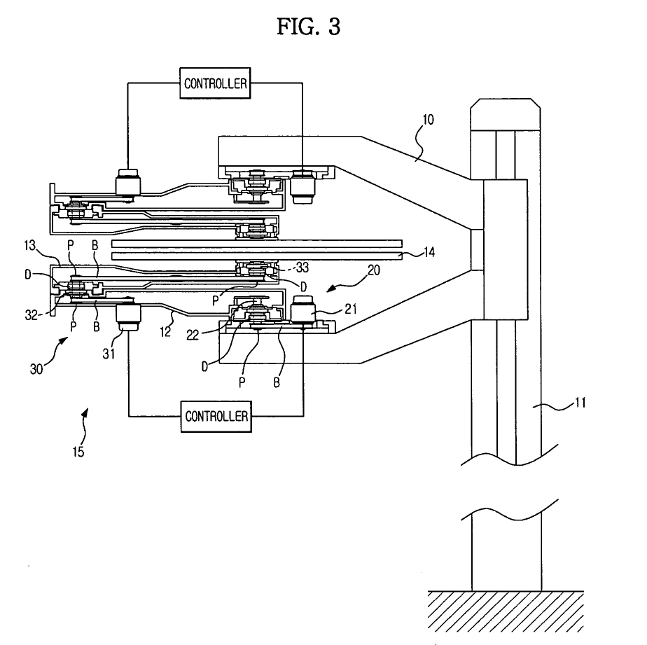

FIG. 3 illustrates a longitudinal cross-sectional view of the wafer transfer robot according to an exemplary embodiment.

As shown in FIGS. 2 and 3, the wafer transfer robot includes a vertically movable arm frame 10 and a robot hand 15 rotatably supported on the arm frame 10 and capable of contracting and extending. The robot hand 15 is provided as a pair of robot hands arranged symmetrically. The robot hand 15 includes a first robot arm 12 rotatably supported on the arm frame 10, a second robot arm 13 supported at the end of the first robot arm 12 to be rotatable with respect to the first robot arm 12, and a wafer holding member 14 capable of holding a wafer and supported at the end of the second robot arm 13 to be rotatable with respect to the second robot arm 13.

Since the robot hand 15 according an exemplary embodiment is provided as a pair of robot hands arranged symmetrically, the following description will be made with respect to the robot hand 15 provided at the relatively lower side.

A first driving device 20 is disposed on the arm frame 10 and the first robot arm 12. A second driving device 30 is disposed on the first robot arm 12, the second robot arm 13 and the wafer holding member 14. The first driving device 20 is installed for the first robot arm 12 to rotate with respect to the arm frame 10. The second driving device 30 is installed for the second robot arm 13 to rotate with respect to the first robot arm 12 when the first driving device 20 is operated and installed for the wafer holding member 14 to rotate with respect to the second robot arm 13.

In this case, although the first driving device 20 can be independently operated, the second driving device 30 should be operated with the first driving device 20. That is, in case of rotating the robot hand 15, the first driving device 20 for rotating the first robot arm 12 is operated, but the second driving device 30 is in a stop state. In case of extending and contracting the robot hand 15 in a radial direction, the first robot arm 12 is rotated by the first driving device 20 and, at the same time, the second robot arm 13 and the wafer holding member 14 are rotated by the second driving device 30. Further, a controller is provided to control whether the first driving device 20 is only operated and whether both the first driving device 20 and the second driving device 30 are operated at the same time.

The arm frame 10 is disposed to be vertically movable on an elevating shaft 11. A driving device such as a rack and pinion gear or a ball screw is disposed in the elevating shaft 11. The arm frame 10 can move up and down on the elevating shaft 11 in one step or in multiple steps by the driving device. Accordingly, the robot hand 15 can move vertically to move the wafer vertically, thereby transferring the wafer to a desired position.

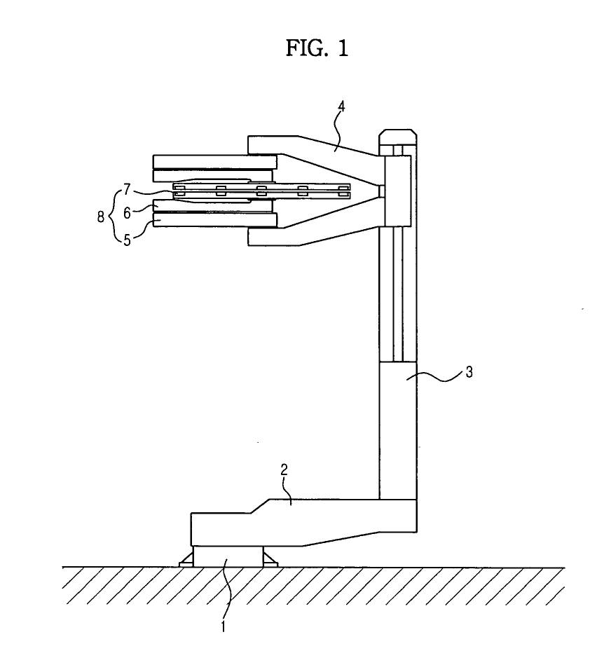

Meanwhile, as shown in FIG. 1, the conventional elevating shaft 3 is installed at the end of the rotation frame 2. In this structure, when the rotation frame 2 is rotated to rotate the robot hand 8, the elevating shaft 3 is also rotated. The elevating shaft 3 serves as a supporting beam of the robot hand 8. When such a supporting beam moves, an error is generated and the wafer may not be transferred accurately.

Further, the elevating shaft 3 and the rotation frame 2 have a mechanical joint coupling. The mechanical joint coupling may decrease an entire strength of the wafer transfer robot.

Compared to the conventional case, as shown in FIG. 3, according to an exemplary embodiment, the elevating shaft 11 is fixed to the bottom such that the elevating shaft 11 cannot be rotated, thereby having an excellent mechanical strength. Accordingly, the robot hand 15 can transfer the wafer with accuracy. In order to rotate the robot hand 15 even though the elevating shaft 11 is fixed to the bottom, it is necessary to improve a driving manner of the robot hand 15. The driving manner of the robot hand 15 according to an exemplary embodiment is explained below.

As described above, the first driving device 20 and the second driving device 30 are disposed on the robot hand 15. First, the first driving device 20 includes a first driving motor 21 embedded in the arm frame 10 and a first transfer device which transfers an output of the first driving motor 21 to the first robot arm 12. The first transfer device includes a first supporting shaft 22, a pulley P and a belt B. The first robot arm 12 is connected to the arm frame 10 by the first supporting shaft 22. The pulley P is disposed at the lower side of the first supporting shaft 22. When the pulley P is connected to the first driving motor 21 by the belt B, the first robot arm 12 rotates forward and backward by a rotational force of the first driving motor 21. In this case, the rotational force of the first driving motor 21 is transferred to the first robot arm 12 through a decelerator D such that the first robot arm 12 can rotate at an appropriate speed.

Next, the second driving device 30 includes a second driving motor 31 embedded in the first robot arm 12 and a second transfer device which transfers an output of the second driving motor 31 to the second robot arm 13 and the wafer holding member 14 in sequence. The second transfer device includes a second supporting shaft 32, a third supporting shaft 33, pulleys P and belts B. The first robot arm 12 is connected to the second robot arm 13 by the second supporting shaft 32. The second robot arm 13 is connected to the wafer holding member 14 by the third supporting shaft 33. The pulleys P are disposed at the upper and lower sides of the second supporting shaft 32, and the pulley P is disposed at the lower side of the third supporting shaft 33. When the second driving motor 31 is connected to the lower pulley P of the second supporting shaft 32 by the belt B and the upper pulley P of the second supporting shaft 32 is connected to the lower pulley P of the third supporting shaft 33 by the belt B, the second robot arm 13 and the wafer holding member 14 are rotated in opposite directions to each other by a rotational force of the second driving motor 31. Also in this case, the rotational force of the second driving motor 31 is transferred to the second robot arm 13 and the wafer holding member 14 through decelerators D such that the second robot arm 13 and the wafer holding member 14 can rotate at an appropriate speed.

A ratio of the rotational speed of the first robot arm 12 to the rotational speed of the second robot arm 13 is 1 to 2, and a ratio of the rotational speed of the second robot arm 13 to the rotational speed of the wafer holding member 14 is 2 to 1. For example, when the first driving motor 21 and the second driving motor 31 have the same output, a ratio of the size of the pulley P of the first supporting shaft 22 to the size of the pulley P of the second supporting shaft 32 is 2 to 1, and a ratio of the size of the pulley P of the second supporting shaft 32 to the size of the pulley P of the third supporting shaft 33 is 1 to 2. Accordingly, a ratio of the rotational speeds of the first robot arm 12, the second robot arm 13 and the wafer holding member 14 is adjusted at 1:2:1. Further, since it is obvious to those skilled in the art that a ratio of the rotational speeds can be adjusted by controlling the decelerators D, the detailed description thereof is omitted.

Hereinafter, the operation principle of the wafer transfer robot according to an exemplary embodiment will be described in detail.

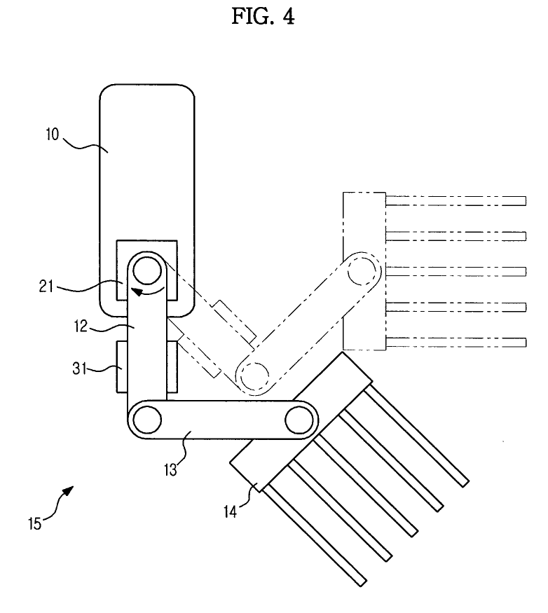

FIG. 4 is an operation state diagram showing the rotation of the robot hand according to an exemplary embodiment.

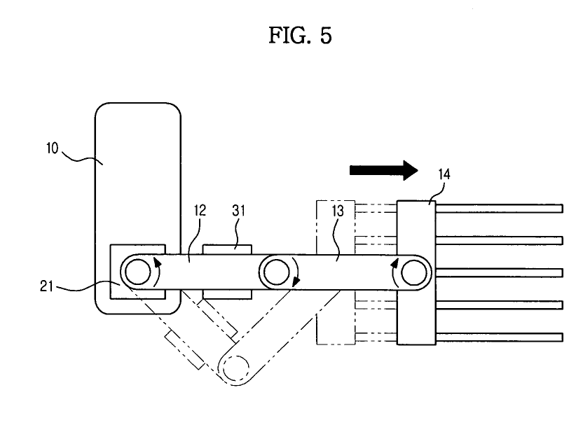

FIG. 5 is an operation state diagram showing the extension and contraction of the robot hand in a radial direction according to an exemplary embodiment.

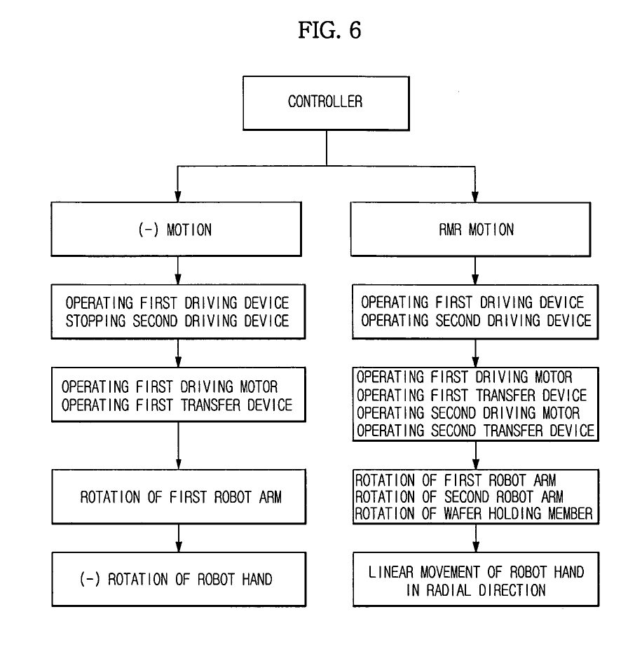

FIG. 6 is an operation flowchart of the controller of the robot hand according to an exemplary embodiment.

As shown in FIGS. 4 to 6, upon receipt of a signal to rotate the robot hand 15, the controller operates the first driving device 20 and stops the second driving device 30 by operating a brake. Accordingly, the first robot arm 12 is rotated by the first driving motor 21 and the first transfer device. Since the second driving motor 31 and the second transfer device are in a stop state, the second robot arm 13 is maintained at a specified angle with respect to the first robot arm 12 and the wafer holding member 14 is maintained at a specified angle with respect to the second robot arm 13.

In the wafer transfer robot according to an exemplary embodiment, the capacity of the motor required for rotating the robot hand 15 is no more than the capacity required for the first driving motor 21 to rotate the first robot arm 12. Accordingly, it is possible to reduce the capacity of the motor that is conventionally required to rotate the rotation frame 2 which supports the robot hand 8, the arm frame 4 and the elevating shaft 3 as shown in FIG. 1.

As shown in FIGS. 5 and 6, upon receipt of a signal to linearly move the robot hand 15, the controller operates both the first driving device 20 and the second driving device 30 at the same time. Accordingly, when the first robot arm 12 is rotated counterclockwise by 45 degrees by the first driving motor 21 and the first transfer device, the second robot arm 13 is rotated clockwise by 90 degrees and the wafer holding member 14 is rotated counterclockwise by 45 degrees by the second driving motor 31 and the second transfer device. The rotation is caused because a ratio of the rotational speeds of the first robot arm 12 and the second robot arm 13 is 1 to 2, and a ratio of the rotational speeds of the second robot arm 13 and the wafer holding member 14 is 2 to 1. Thus, the robot hand 15 is contracted in a radial direction to transfer the wafer in a linear direction.

As described above, the robot hand 15 according to an exemplary embodiment is provided as a pair of robot hands on the arm frame 10. The robot hand 15 includes the first robot arm 12, the second robot arm 13 and the wafer holding member 14. The first driving device 20, the second driving device 30 and the controller are disposed to drive the first robot arm 12, the second robot arm 13 and the wafer holding member 14. Thus, the pair of robot hands can be separately rotated without interference while extending and contracting in a radial direction.

By the above-described configuration, the wafer transfer robot can be rotated and linearly move in a radial direction by providing the first driving device and the second driving device on the robot hand. Thus, exemplary embodiments have an effect of greatly decreasing the capacity of the motor serving as a driving device and reducing the cost.

Further, since there is no need to rotate the entire wafer transfer robot, the rotational inertia decreases to reduce the capacity of the decelerator and the driving device required to configure a rotation unit and also reduce the capacity of the controller. Thus, the unit cost of the respective components becomes low, thereby reducing the price of the wafer transfer robot.

Further, the mechanical joint coupling is unnecessary when the elevating shaft is mounted on the rotation frame by fixing the elevating shaft of the wafer transfer robot on the bottom, thereby improving the entire strength of the wafer transfer robot. Thus, there is an effect of highly improving accuracy and precision of the wafer transfer.

Although a few exemplary embodiments have been shown and described, it would be appreciated by those skilled in the art that changes may be made in these exemplary embodiments, the scope of which is defined in the claims and their equivalents.

What is claimed is:

1. A wafer transfer robot having at least robot hand to transfer a wafer comprising:
an arm frame supported on an elevating shaft to vertically move the robot hand, wherein the robot hand includes:
a first robot arm rotatably supported on the arm frame;
a second robot arm rotatably supported at an end of the first robot arm;
a first driving device which rotates the first robot arm to rotate the robot hand;
a second driving device which rotates the second robot arm to extend and contract the robot hand in a radial direction with the first driving device; and
a controller which operates the first driving device and stops the second driving device when the robot hand is rotated, and operates both the first driving device and the second driving device at the same time when the robot hand is extended and contracted in a radial direction.

2. The wafer transfer robot according to claim 1, wherein when the first driving device and the second driving device are operated at the same time, the first robot arm and the second robot arm rotate in opposite directions to each other, and a rotational speed of the second robot arm is twice a rotational speed of the first robot arm.

3. The wafer transfer robot according to claim 1, further comprising a wafer holding member rotatably supported on the second robot arm, wherein the second robot arm and the wafer holding member rotate in opposite directions to each other, and a rotational speed of the second robot arm is twice a rotational speed of the wafer holding member.

4. The wafer transfer robot according to claim 1, wherein the first driving device includes a first driving motor and a first transfer device which transfers an output of the first driving motor to the first robot arm.

5. The wafer transfer robot according to claim 4, wherein the first transfer device includes a first supporting shaft which connects the arm frame and the first robot arm and a belt which transfers the output of the first driving motor to the first supporting shaft.

6. The wafer transfer robot according to claim 1, wherein the second driving device includes a second driving motor and a second transfer device which transfers an output of the second driving motor to the second robot arm and the wafer holding member.

7. The wafer transfer robot according to claim 6, wherein the second transfer device includes a second supporting shaft which connects the first robot arm and the second robot arm, a third supporting shaft which connects the second robot arm and the wafer holding member, and a belt which transfers the output of the second driving motor to the second supporting shaft and the third supporting shaft.

8. The wafer transfer robot according to claim 1, wherein the robot hand is provided as a pair of robot hands on the arm frame to be vertically symmetrical.

9. A wafer transfer robot including a robot hand for transferring a wafer, the robot comprising:
a first robot arm;
a second robot arm rotatably supported at an end of the first robot arm;
a first driving device which rotates the first robot arm to rotate the robot hand;
a second driving device which rotates the second robot arm to extend and contract the robot hand in a radial direction with the first driving device; and
a controller which operates the first driving device and stops the second driving device when the robot hand is rotated, and operates both the first driving device and the second driving device at the same time when the robot hand is extended and contracted in a radial direction.

10. The wafer transfer robot according to claim 9, further comprising an arm frame supported on an elevating shaft to vertically move the robot hand.

11. The wafer transfer robot according to claim 10, wherein the robot hand is provided as a pair of robot hands on the arm frame to be vertically symmetrical.

12. The wafer transfer robot according to claim 9, wherein when the first driving device and the second driving device are operated at the same time, the first robot arm and the second robot arm rotate in opposite directions to each other, and a rotational speed of the second robot arm is twice a rotational speed of the first robot arm.

13. The wafer transfer robot according to claim 9, further comprising a wafer holding member rotatably supported on the second robot arm, wherein the second robot arm and the wafer holding member rotate in opposite directions to each other, and a rotational speed of the second robot arm is twice a rotational speed of the wafer holding member.

14. The wafer transfer robot according to claim 9, wherein the first driving device includes a first driving motor and a first transfer device which transfers an output of the first driving motor to the first robot arm.

15. The wafer transfer robot according to claim 14, further comprising an arm frame supported on an elevating shaft to vertically move the robot hand.

16. The wafer transfer robot according to claim 15, wherein the first transfer device includes a first supporting shaft which connects the arm frame and the first robot arm and a belt which transfers the output of the first driving motor to the first supporting shaft.

17. The wafer transfer robot according to claim 9, wherein the second driving device includes a second driving motor and a second transfer device which transfers an output of the second driving motor to the second robot arm and the wafer holding member.

18. The wafer transfer robot according to claim 17, wherein the second transfer device includes a second supporting shaft which connects the first robot arm and the second robot arm, a third supporting shaft which connects the second robot arm and the wafer holding member, and a belt which transfers the output of the second driving motor to the second supporting shaft and the third supporting shaft.
